(19) United States
(12) Patent Application Publication
(10) Pub. No.: US 2004/0111278 A1
(43) Pub. Date: Jun. 10, 2004

(54) Method of quantifying loss of quality of life resulting from personal injury for tort cases

(76) Inventors: Gary C. Brown, Flourtown, PA (US); Melissa M. Brown, Flourtown, PA (US); Sanjay Sharma, Kingston (CA)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/313,502

(22) Filed: Dec. 6, 2002

(51) Int. Cl. G06F 17/60

(52) U.S. Cl. 705/1; 705/4

(57) ABSTRACT

A method and system which numerically quantifies a person's loss of quality of life (QOL), i.e., the value of remaining life, due to the occurrence of an injury. The system includes a processor in communication with a health-related QOL measures (e.g., health state utility value) database. Raw data are inputted into the processor. The raw data provide information regarding the person's life expectancy and health state before and after the occurrence of the injury. The processor calculates a reference value of the person's QOL as if the injury did not occur. The processor then calculates the person's actual loss of value of QOL due to the occurrence of the injury. Finally, the processor calculates a QOL disability index by dividing the person's actual loss of value of QOL by the reference value. The QOL disability index is used to determine an amount of monetary damages to be awarded in a tort case.

### BACKGROUND OF THE INVENTION

Outcomes from treatments and other health-influencing activities have two basic components: the quantity and quality of life. Life expectancy is a traditional measure with few problems of comparison, whereby people are either alive or they are not.

A patient preference is the desirability of a particular health state. A perfect health state is highly desirable, while the health state of a severe stroke is certainly undesirable. A number of different methods have been used in an attempt to measure and value quality of life (QOL) associated with a health state, including utility value analysis. By convention, health state utility values range from 1.0 (perfect health) to 0.0 (death). The closer the health state utility value is to 1.0, the higher the QOL associated with a health state, while the closer the value is to 0.0, the poorer the QOL associated with a health state.

Utility analysis was originally developed to quantify uncertainty. Although initially applied to other fields, utility analysis entered the health care arena in the 1970's. There are several variants of utility analysis, the most important of which are the time tradeoff and standard gamble methodologies. The time tradeoff method of utility analysis was developed by George Torrance in 1972 specifically for use in health care.

The quality adjusted life year (QALY) was created to combine the quantity and QOL using these utility values to assess the QOL associated with a health state. The amount of time spent in a particular health state is weighted by the utility score given to that health state. It takes one year of perfect health (utility score of 1) to equal one QALY. A health state valued over one year at a utility value of 0.5 is equivalent to half a QALY. The amount of time in a health state is also an important factor related to QOL. For example, a person with a stroke that reverses in one month is certainly better off than one with permanent impairment. The term QALY incorporates health state utility value measures with time and calculates the total health-related QOL. The concept of the QALY was first described by Klarman et al. in a 1968 paper entitled “Cost-effectiveness Applied to the Treatment of Chronic Renal Disease”.

With the time tradeoff method of utility analysis, patients with a specific health state are asked how many years they anticipate they will live. They are next asked how many of those years, if any, they would be willing to trade in for the return and/or maintenance of guaranteed, permanent good health. The person's health state utility value is then calculated by subtracting the proportion of years traded from 1.0. For example, a person with diabetes who anticipates living 40 years states that he or she would trade 8 years of life to be rid of the diabetes. The subsequent health state utility value is 1.0−(8/40)=0.80. A treatment that would immediately cure diabetes permanently and prevent subsequent diabetic-related sequelae, would thus improve this person's health state utility value from 0.80 to 1.00, a net gain in health state utility value of 0.20.

Standard gamble utility analysis involves presenting a person with a given health state two choices. The first choice is to remain in the same health state, in which case the health state utility value would equal 1.00. The second choice is to undergo a procedure that would have a probability “x” of permanently alleviating the person's symptomatology, but at the same time the person would be risking immediate death. A resultant health state utility value is then calculated by determining the point of indifference between these two alternatives (1−x). For example, a person with a moderate stroke who is willing to risk up to a 40% chance of immediate death, with the other alternative being a permanent cure, has a health state utility value of 1.0-0.40, or 0.60.

Scaling methods, such as the visual analog scale, typically ask a patient where he or she would place their QOL related to their health state on a scale from 0 (death) to 100 (perfect health). The result can theoretically be used to calculate quality-adjusted life-years in a manner similar to that done with health state utility values.

By convention, the number of quality-adjusted life-years a patient possesses is calculated by multiplying their health state utility value times the remaining years of life. As an example, a diabetic with a health state utility value of 0.80 and 10 expected remaining years of life would have 8.0 QALYs (0.8×10) remaining, while with a 20 year life expectancy there would be 16.0 QALYs (0.8×20) remaining. This number of QALYs can therefore be viewed as the overall value of a person's remaining life. Therapies that improve the health state utility value and/or length of life can add to the number of QALYs, while insults that decrease the health state utility value and/or length of life decrease the overall remaining value of that life.

A tort action which involves a personal injury that causes a person to lose varying degrees of QOL over a period of years is difficult and time consuming to analyze. Furthermore, comparison data upon which an analysis is performed are not always readily available. What is needed is a method and system for objectively measuring QOL issues by incorporating patient-based preferences to provide a common standard for the quantification of “pain and suffering” as related to torts.

### SUMMARY OF THE INVENTION

The present invention is a computer-implemented method and system for numerically quantifying a person's loss of quality of life (QOL), i.e., the value of remaining life, due to the occurrence of an injury. The system includes a processor, a health-related QOL measures database in communication with the processor, and a user interface in communication with the processor. The user interface is used to input raw data into the processor. The raw data provide information regarding the person's life expectancy and health state before and after the occurrence of the injury. The processor calculates a reference value of the person's QOL as if the injury did not occur, using information included in the raw data regarding the person's life expectancy, health state prior to the occurrence of the injury, and one or more health-related QOL measures obtained from the database. The processor calculates the person's actual loss of value of QOL due to the occurrence of the injury, using the reference value, information in the raw data regarding the person's life expectancy and health state after the occurrence of the injury, and one or more health-related QOL measures obtained from the database. The processor calculates a QOL disability index by dividing the person's actual loss of value of QOL by the reference value of QOL. The QOL disability index numerically quantifies the person's loss of value of QOL due to the occurrence of the injury. The health-related QOL measures include at least one health state utility value.

The QOL disability index may be used to determine an amount of monetary damages to be awarded in a tort case. Each of the health state utility values may be determined based on a ratio of (i) a proportion of remaining time of life the average surveyed person would be willing to forfeit living in exchange for eliminating a loss of value of QOL, and (ii) the amount of time that the surveyed person expects to experience the loss of value of QOL. Each of the health state utility values may be based on the opinions of a plurality of surveyed people who experienced a loss of value of QOL similar to the person's loss of value of QOL. The raw data may include a parameter which indicates a period of time that the person is expected to live after the occurrence of the injury. The raw data may include one or more parameters which indicate a period of time for each of one or more injury recovery phases that the person experiences. Each of the health state utility values obtained from the database may be multiplied by the duration of a health state associated with the health state utility value experienced by the person to indicate at least a portion of the extent of the person's loss of value of QOL.

### BRIEF DESCRIPTION OF THE SEVERAL VIEWS OF THE DRAWING

The following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a block diagram of a quality of life (QOL) analysis system in accordance with a preferred embodiment of the present invention; and

FIG. 2 is a flow chart including method steps used to practice the present invention.

### DETAILED DESCRIPTION OF THE INVENTION

A uniform database of health state utility values is provided in accordance with the present invention. The database includes data based on numerous interviews with patients who have experienced a specific health state on a firsthand basis. The database allows a comparison of almost any health state induced by an adverse event. The number of quality-adjusted life-years lost is a standardized number that can be compared for any person with any specific health state. Health state utility values are independent of gender, race, education, income and age (i.e., they are innate to human nature). A proprietary database consisting of the results of interviewing 7,500 patients who experienced a specific health state on a firsthand basis has already been developed for use with the present invention.

The present invention provides an objective, patient preference-based information system for the quantification the degree of “pain and suffering” by measuring loss of value of QOL as related to tort actions.

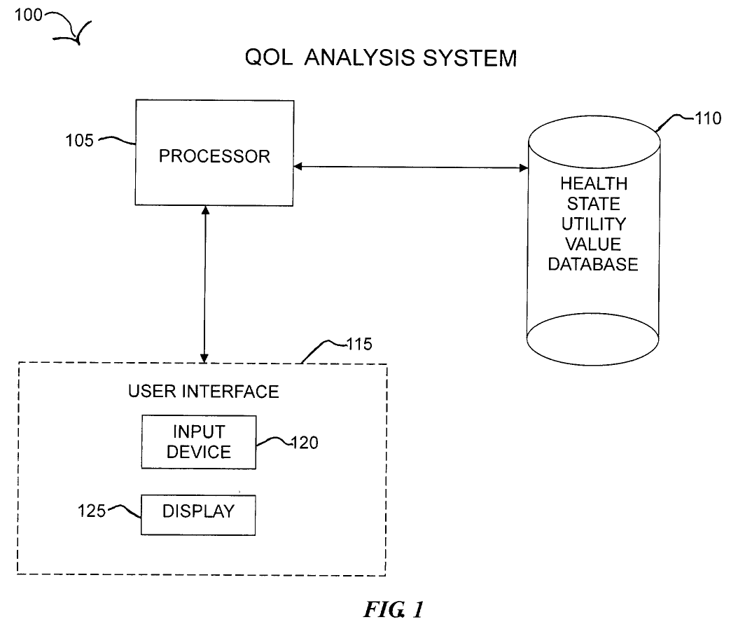

In a preferred embodiment of the present invention, a computer-implemented method of numerically quantifying an injured person's loss of QOL is implemented in a QOL analysis system 100 as shown in FIG. 1. The QOL analysis system 100 includes a processor 105 which is in communication with a health state utility value database 110 and a user interface 115. The user interface 115 includes an input device 120, such as a keyboard, mouse or the like, and a display 125 on which a raw data input menu may be presented for selecting and inputting various parameters used to perform a QOL analysis.

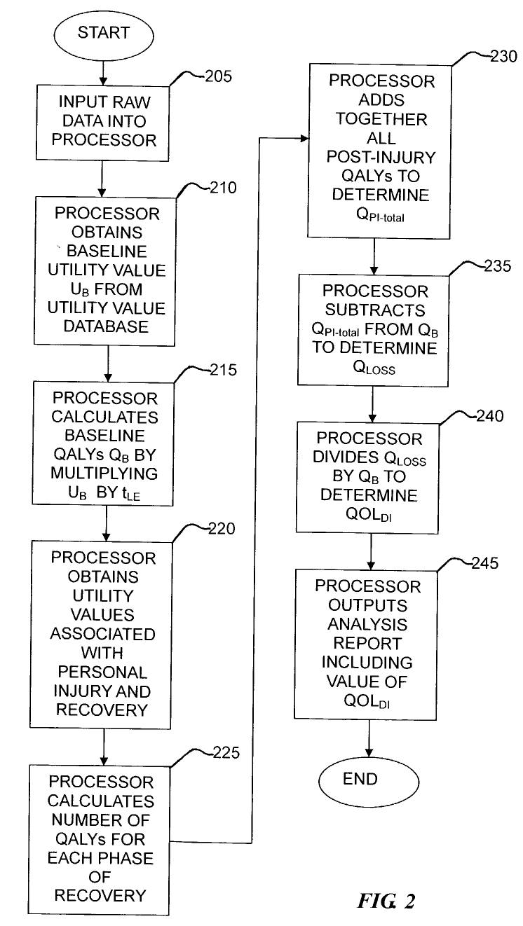

FIG. 2 is a flow chart which includes method steps that are implemented according to the preferred embodiment of the present invention. In step 205, the user interface 115 is used to input raw data into the processor 105 to determine perform a QOL analysis for an injured person. The raw data provide the processor 105 with a baseline (B) health state status of the person and a post-injury (PI) health status. The baseline health state status is based on an assumption that the specific injury which caused a loss of value of QOL for the person did not occur. The raw data also include the period of time t_{LE} that the person is expected to live after the occurrence of a personal injury. This life expectancy t_{LE} may be determined in years or a fraction thereof from actuarial survival tables. The raw data also specify the details of the injured person's loss of value of QOL (e.g., a broken arm, brain damage, diabetes, etc.), the time (in years or fraction thereof) that the injured person has spent and/or is expected to spend in each of one or more recovery phases (e.g., Tₜ₁, Tₜ₂), and the remaining life expectancy (T_{tF}) (in years or fraction thereof) that the person is anticipated to spend in a final (F) health state after the injured person's recovery treatment has been completed.

In response to receiving the raw data from the user interface 115, the processor 105 obtains a baseline reference health state utility value U_{B} from health state utility value database 110 (step 210). The baseline health state status may be normal, or it may be the expected result after a medical intervention. For example, if the baseline health state status is normal, the baseline reference health state utility value U_{B} will typically be 1.0. For a person who experiences an ocular injury, if the person previously had cataract surgery with a final visual acuity result of 20/25 vision in the operated eye and 20/20 vision in the other eye, the baseline reference health state utility value U_{B} may be 0.97. Each health state utility value stored in health state utility value database 110 is associated with a particular loss of value of QOL and typically represents an average of a plurality of values obtained by surveying other people who experienced the particular loss of value of QOL.

In step 215, the processor 105 calculates the number of baseline QALYs Q_{B} that the patient would have gained at baseline health status during the remainder of his or her life if the personal injury to the person had not occurred, by multiplying the baseline reference health state utility value U_{B} by the life expectancy t_{LE} as follows:

U_{B}×t_{LF}=Q_{B}

where the number of baseline QALYS Q_{B} serves as a reference value of the injured person's QOL as if the injury did not occur.

In step 220, the processor 105 analyzes the raw data and obtains from the health state utility value database 110 one or more health state utility values (e.g., Uₜ₁, Uₜ₂) associated with one or more recovery phases experienced by the person subjected to a loss of value of QOL, and a final health state utility value U_{tF} associated with the final health state of the injured person after recovery has been completed. For example, a person hospitalized after a severe automobile injury has a health state utility value Uₜ₁ of 0.09 during the period of hospitalization (first recovery phase). When at home undergoing rehabilitation for a fractured hip, the person has a health state utility value Uₜ₂ of 0.60 (second recovery phase). Upon completing rehabilitation, the person still requires the use of a cane while walking, and thus the person will have a final health state utility value U_{tF} of 0.75 for the rest of that person's life.

In step 225, the processor 105 individually calculates the number of QALYs associated with each recovery phase Q_{T1}, Q_{T2}, Q_{TF} by multiplying the health state utility value associated with each recovery phase Uₜ₁, Uₜ₂, U_{tF} by the respective time spent in that recovery phase Ti, Tₜ₂, T_{tF} as follows:

Uₜ₁×Tₜ₁=Q_{T1}

Uₜ₂×Tₜ₂=Q_{T2}

U_{tF}×T_{tF}=Q_{TF}.

In step 230, the processor 105 adds together Q_{T1}, Q_{T2}, Q_{TF} as follows:

Q_{T1}+Q_{T2}+Q_{TF}=Q_{PI-tota1}

to determine the total number of lifetime post-injury (PI) QALYs remaining after the personal injury to the person occurred.

In step 235, the processor 105 subtracts the number of lifetime QALYs Q_{PI-total} from the number of baseline QALYs Q_{B} where Q_{B}−Q_{PI-total}=the actual number of QALYs lost (Q_{Loss}) due to the personal injury.

In step 240, the processor 105 then divides the number of QALYs lost due to the personal injury Q_{Loss} by the baseline number of QALYs Q_{B}. The ratio Q_{Loss}÷Q_{B} is the percent of actual QOL lost as a result of the personal injury, and is the QOL_{DI} (quality of life disability index). The QOL_{DI} quantifies “pain and suffering,” a measure of non-economic damage in a tort case that occurs due to the personal injury and is used to determine the amount of monetary damages to be awarded.

In step 245, the processor 105 outputs an analysis report which includes at least the value of QOL_{DI}. This can occur in undiscounted form and/or in the form of sensitivity analysis incorporating various yearly discount rates commonly used in general economic and healthcare economic analyses. The report may be displayed on display 125 of user interface 115, printed out on a printer (not shown), or transmitted via any known electronic communication means to a remote location.

In one embodiment, each health state utility value in the health state utility value database 110 is calculated by subtracting from 1.0 the proportion of theoretical remaining time of life a person with a detrimental health state would be willing to forfeit, if any, to have their health state returned to normal. For example, a person who would be willing to trade 2 of 10 remaining years of years of life to be free of diabetes would have a health state utility value of 1.0−2/10=0.80. This has also been referred to as the time tradeoff methodology of utility analysis.

In another embodiment, each health state utility value in the health state utility value database 110 is calculated by subtracting from 1.0 the theoretical percent risk of immediate death a person is willing to assume, if any, given the alternative of having their health state returned to normal. For example, a person with marked angina who is willing to assume a 35% risk of immediate death given the alternative is a complete resolution of the angina, would have a health state utility value of 1.0−0.35=0.65. This has also been referred to as the standard gamble methodology of utility analysis.

In yet another embodiment, each health state utility value in the health state utility value database 110 is calculated by using a scaling methodology to evaluate their health state where a QOL ratio is the number in percent. For example if a person with osteoarthritis of the hip who is asked to rate their QOL (on a scale from 0, which usually indicates death, to 100, which usually indicates perfect health), replies with the number 65, that person has a health state utility value of 0.65.

In yet another embodiment, each health state utility value in the health state utility value database 110 is calculated by subtracting from 1.0 a QOL ratio obtained using a QOL measurement instrument such as the “quality of well-being” (QWB) scale, the Medical Outcomes Short Form-36 (SF-36), or any other methodology that asks multiple health-related questions with the intention of objectively measuring the QOL associated with a given health state.

In yet another embodiment, each health state utility value in the health state utility value database 110 is calculated by subtracting from 1.0 the sum of health state utility value loss occurring secondary to separate symptoms and signs of an injured person, such as pain, psychologic damage, the inability to see, walk perform self care, etc. These methodologies have been referred to as generic health state classifications systems, and include the Health Utilities Index (HUI) Scale and the EuroQol5D.

In yet another embodiment, the loss of value of QOL (or burden of a disability or injury) is measured using the disability-adjusted life-year (DALY), an indicator of the time and value of time lived with a disability. As with the other embodiments, the economic methodology of discounting for the time value of health related outcomes may be employed.

In yet another embodiment, each health state utility value in the health state utility value database 110 is calculated by subtracting from 1.0 the proportion of their wealth, annual income, or some other monetary measure, they would be willing to trade in return for the guaranteed return to a normal health state. For example, a person with severe depression who has a worth of $1 million and is willing to forfeit $400,000 in return for a normal health state, has a health state utility value of 1.0−$400,000/$1,000,000=1.0−0.40=0.60. This has been referred to as the willingness-to-pay methodology of utility value analysis.

The following illustrates an example of an analysis of an injured person's loss of value of QOL in accordance with the present invention. A fifty-year-old woman with a history of mild osteoarthritis of each hip is involved in an automobile accident and sustains a fracture of her right hip. She is hospitalized for one month, during which time she undergoes a right total hip replacement. She subsequently undergoes a course of rehabilitation therapy for an additional 5 months, during which time she is disabled at two different levels:

(1) American College of Rheumatology Classification Class IV—limited in ability to perform usual self-care, vocational and avocational activities for two months; and

(2) American College of Rheumatology Classification Class III—able to perform usual self-care activities, but limited in vocational and avocational activities for three months.

After her rehabilitation therapy, the fifty-year-old woman is then permanently able to carry on vocational activity with mild effort, but is still limited in avocational activities (American College of Rheumatology Classification Class II—able to perform usual self-care and vocational activities, but limited in avocational activity).

The fifty-year-old woman is contemplating pursuing a lawsuit to recover economic damages as well as compensation for “pain and suffering”, including but not limited to “loss of life's pleasures”, “loss of spousal consort,” etc. The present invention may be used to determine the amount of pain and suffering involved in this case.

Prior to the accident, the fifty-year-old woman experienced mild osteoarthritis of her hips. A user of the QOL analysis system inputs raw data into processor 105 via user interface 115 indicating that the fifty-year-old woman has a baseline hip-injury which occurred prior to the accident. Based on the raw data, the processor 105 obtains a baseline reference health state utility value U_{B} of 0.99 from the health state utility value database 110. It has been noted in the peer-reviewed literature that the hip injury and subsequent total hip replacement surgery will have no effect upon her longevity.

Additionally, the raw data indicate that at the time of her injury, the fifty-year-old woman has a mean life expectancy t_{LE} of 32.0 years. The number of baseline quality-adjusted life-years she would have gained through her lifetime without the injury, Q_{B}.=U_{B}×t_{LE}=0.99×32.0=31.68.

The raw data also indicate that the fifty-year-old woman experienced four recovery phases during her recovery including:

(1) Recovery phase 1: hospitalization for acute trauma and total hip surgery;

(2) Recovery phase 2: American College of Rheumatology Classification Class IV for hip disease;

(3) Recovery phase 3: American College of Rheumatology Classification Class III for hip disease; and

(4) Final phase 4: final health state after recovery is completed—American College of Rheumatology Classification Class II for hip disease.

Based on the raw data, the processor 105 obtains health state utility values from the health state utility value database 110 that correspond to these four recovery phases as follows: Uₜ₁=0.09; Uₜ₂₌0.52; Uₜ₃=0.79; and U_{tF}=0.95. The raw data also include times spent (in years or portions thereof) in each recovery phase as follows: Tₜ₁=0.083; Tₜ₂=0.167; Tₜ₃=0.25; and T_{tF}=31.5. The processor 105 calculates the number of QALYs associated with each recovery phase as follows:

Q_{T1}=Uₜ₁×Tₜ₁=0.09×0.083=0.00747; (1)

Q_{T2}=Uₜ₂×Tₜ₂=0.52×0.167=0.08684; (2)

Q_{T3}=Uₜ₃×Tₜ₃=0.79×0.25=0.1975; and (3)

Q_{TF}=U_{tF}×T_{tF}=0.95×31.5=29.925. (4)

The processor 105 calculates the total number of post-injury (PI) QALYS remaining after the personal injury to the fifty-year-old woman occurred as follows:

Q_{PI-total}=Q_{TI}+Q_{T2}+Q_{T3}+Q_{TF}=0.00747+0.08684+0.1975+29.925=30.2168 quality-adjusted life-years. The processor 105 then subtracts Q_{PI-total} from the number of baseline quality-adjusted life-years she would have gained through her lifetime without the injury Q_{B} to determine Q_{Loss} as follows:

Q_{Loss}=Q_{B}−Q_{PI-total}=31.68−30.2168=1.463. The processor 105 then divides Q_{Loss} by Q_{B} to obtain the QOL disability index QOL_{DI}. In this case, QOL_{DI}=1.463÷31.68=4.62%, which indicates that the fifty-year-old woman has experienced a diminution in her total remaining value of QOL of 4.62% from her injury. The processor 105 then forwards an analysis report including the value of QOL_{DI} to the user interface or other device for review.

To decide upon a tort award, the QOL index will be used as a multiplier in conjunction with the value of a human life to arrive at an objective and just award. For example, if in regard to non-economic damages it was decided by a respected, appointed or otherwise decided society party that the value of a year of human life (irrespective of economic conditions) is $100,000, the loss of 4.62% of value would represent $4,620/year.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A computer-implemented method of numerically quantifying a person's loss of quality of life (QOL) due to the occurrence of an injury, the method being implemented in a system including a processor in communication with a health-related QOL measures database, the method comprising:
(a) inputting raw data into the processor, the raw data providing information regarding the person's life expectancy and health state before and after the occurrence of the injury;
(b) the processor calculating a reference value of the person's remaining QOL as if the injury did not occur, using information included in the raw data regarding the person's life expectancy, health state prior to the occurrence of the injury, and one or more health-related QOL measures obtained from the database;
(c) the processor calculating the person's actual loss of value of QOL due to the occurrence of the injury, using the reference value, information in the raw data regarding the person's life expectancy and health state after the occurrence of the injury, and one or more health-related QOL measures obtained from the database; and
(d) the processor calculating a QOL disability index by dividing the person's actual loss of value of QOL by the reference value, wherein the QOL disability index numerically quantifies the person's loss of QOL due to the occurrence of the injury.

2. The method of claim 1 wherein the QOL disability index is used to determine an amount of monetary damages to be awarded in a tort case.

3. The method of claim 1 wherein each of the health health-related QOL measures is determined based on a ratio of (i) a proportion of remaining time of life a surveyed person would be willing to forfeit living in exchange for eliminating a loss of value of QOL, and (ii) the amount of time that the surveyed person expects to experience the loss of value of QOL.

4. The method of claim 1 wherein each of the health-related QOL measures is based on the opinions of a plurality of surveyed people who experienced a loss of value of QOL similar to the person's loss of value of QOL.

5. The method of claim 1 wherein the raw data include one or more parameters which indicate a period of time for each of one or more injury recovery phases that the person experiences.

6. The method of claim 1 wherein each of the health-related QOL measures obtained from the database is multiplied by the duration of a health state associated with the health-related QOL measure experienced by the person to indicate at least a portion of the extent of the person's loss of value of QOL.

7. The method of claim 1 where the health-related QOL measures include at least one health state utility value.

8. A system for numerically quantifying a person's loss of quality of life (QOL) due to the occurrence of an injury, the system comprising:
(a) a processor;
(b) a health-related QOL measures database in communication with the processor; and
(c) a user interface in communication with the processor, the user interface being used to input raw data into the processor, the raw data providing information regarding the person's life expectancy and health state before and after the occurrence of the injury, wherein the processor:
(I) calculates a reference value of the person's QOL as if the injury did not occur, using information included in the raw data regarding the person's life expectancy, health state prior to the occurrence of the injury, and one or more health-related QOL measures obtained from the database;
(II) calculates the person's actual loss of value of QOL due to the occurrence of the injury, using the reference value, information in the raw data regarding the person's life expectancy and health state after the occurrence of the injury, and one or more health-related QOL measures obtained from the database; and
(III) calculates a QOL disability index by dividing the person's actual loss of value of QOL by the reference value, wherein the QOL disability index numerically quantifies the person's loss of QOL due to the occurrence of the injury.

9. The system of claim 8 wherein the QOL disability index is used to determine an amount of monetary damages to be awarded in a tort case.

10. The system of claim 8 wherein each of the health-related QOL measures is determined based on a ratio of (i) an proportion of remaining time of life a surveyed person would be willing to forfeit living in exchange for eliminating a loss of value of QOL, and (ii) the amount of time that the surveyed person expects to experience the loss of value of QOL.

11. The system of claim 8 wherein each of the health-related QOL measures is based on the opinions of a plurality of surveyed people who experienced a loss of value of QOL similar to the person's loss of value of QOL.

12. The system of claim 8 wherein the raw data includes one or more parameters which indicate a period of time for each of one or more injury recovery phases that the person experiences.

13. The system of claim 8 wherein each of the health-related QOL measures obtained from the database is multiplied by the duration of a health state associated with the health-related QOL measure experienced by the person to indicate at least a portion of the extent of the person's loss of value of QOL.

14. The system of claim 8 where the health-related QOL measures include at least one health state utility value.
